(19) United States
(12) Patent Application Publication
(10) Pub. No.: US 2003/0187843 A1
(43) Pub. Date: Oct. 2, 2003

(54) Method and system for searching for a list of values matching a user defined search expression

(76) Inventor: Robert Y. Seward, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/114,681

(22) Filed: Apr. 2, 2002

(51) Int. Cl. G06F 7/00

(52) U.S. Cl. 707/5

(57) ABSTRACT

A method and system for performing a regular expression comparison between a search expression and a list of values having a first term as a regular expression term and performing a regular comparison between the search expression and a list of values having a first term as a nonregular expression term.

### FIELD OF THE INVENTION

The present invention generally concerns searching methods using user defined search expressions. The method of the invention more specifically concerns searching methods in a data structure.

### BACKGROUND OF THE INVENTION

Most typical searches require a user defined search expression (e.g., a user defined search string) and a data structure (e.g., a database, radix tree or dictionary) for searching against the user defined search expression. Generally, the search expression is a single pattern, and it is often in the form of a regular expression. A regular expression is an expression that contains a wildcard pattern, such as a string that matches (1) any character (e.g., “.”), (2) zero or more of any character (e.g., “.*”) or (3) the string inside the parentheses zero or one times (e.g., “( )?”). For example, a regular expression “Al(fred|len|ly).*” will match nonregular expressions (i.e., an expression without a wildcard pattern) including “Al,” “Alfred,” “Allen” and “Ally.” Typically, a user enters a regular expression (i.e., an expression with wildcard patterns) for searching against a data structure with multiple strings of nonregular expressions, and a search method must search through all the strings in the data structure to return all the matches. However, the process exhausts considerable time, depending on the size of the data structure, since every string in the data structure must be examined and compared.

Another available search method involves a single user defined search expression, which is a nonregular expression (i.e., an expression without a wildcard pattern), for searching against a data structure with regular and nonregular expressions. Because the values in the data structure are defined by both regular and nonregular expressions, the data structure is more complicated since each regular expression can contain multiple variations. Thus, a typical search process, using the traditional method of searching every string in the data structure, will take an even longer time.

As a result, this may not be workable for data structure with thousands of patterns, such as an electrical netlists. An electrical netlist is generally used to describe a group of logically related nets, including connectivity data for each net, in a circuit chip. For example, the netlist may contain a lists of commands that are to be applied to a design object, such as nets, instances, cells or/and ports. Also, the design objects to which the commands are applied can be expressed in a regular expression. For example, “clk” is a commonly used term to refer to a clock in a circuit design, and the term “clk” is generally followed by another object, such as “buf”, “in” or “out”. The “clk” term can be express in a regular expression “clk_(in|out|buf).*” to include “clk_in”, “clk_out” or “clk_buf”, and a single value is used rather than three separate values. Another example is the term “buf”, which is generally used after another object in a netlist, we can use a regular expression “.*bufs” and capture multiple entries with just a single value. Thus, the use of regular expression becomes quite useful, especially with netlists of enormous size and complexity.

Another implementation involving a similar structure is a word dictionary. For example, a regular expression of “follow(s|ed|ing)?” is used to represent follow, follows, followed and following, or a spelling variation of a word, such as “instruct[ie]r,” can be used to include proper and improper spellings of “instructor.” The typical method is not designed to search these regular expressions efficiently, and as a result, the time needed to complete a search is extended unnecessarily.

### BRIEF SUMMARY OF THE INVENTION

In the present invention, only parts of the data structure will be used to searched against the search expression. Not every point (e.g., key of a node) of the data structure need to be processed, rather the present invention process the portion of the data structure that would most likely match the search expression. As a result, the length of the search time depends upon the length of the search expression, rather than the length of the data structure. In particular, a regular expression comparison is first performed between a search expression and values with a first term being a regular expression character, and followed by another regular expression comparison between the search expression and values with a first term matching a first term in the search expression. For any matched values found, they are added to a match list.

### DESCRIPTION OF THE DRAWINGS

FIG. 1 shows a block diagram of a computer system including a data structure organized to implement an embodiment of the invention;

FIG. 2 is a flow chart according to an embodiment of the present invention illustrating the functionality of a method for searching a search expression through a data structure;

FIG. 3 is a flow chart according to an embodiment of the present invention illustrating the functionality of a method for building a data structure;

FIG. 4 shows exemplary radix keys using user defined entries of pattern and associated data generated from the method shown in FIG. 3; and,

FIG. 5 shows an exemplary radix tree data structure generated using the user defined entries of pattern and associated data and the radix keys shown in FIG. 4.

### DETAILED DESCRIPTION

In the present invention, only parts of the data structure will be used to searched against the search expression. Not every point (e.g., key of a node) of the data structure need to be processed, rather the present invention process the portion of the data structure that would most likely match the search expression. As a result, the length of the search time is depended upon the length of the search expression, rather than the length of the data structure.

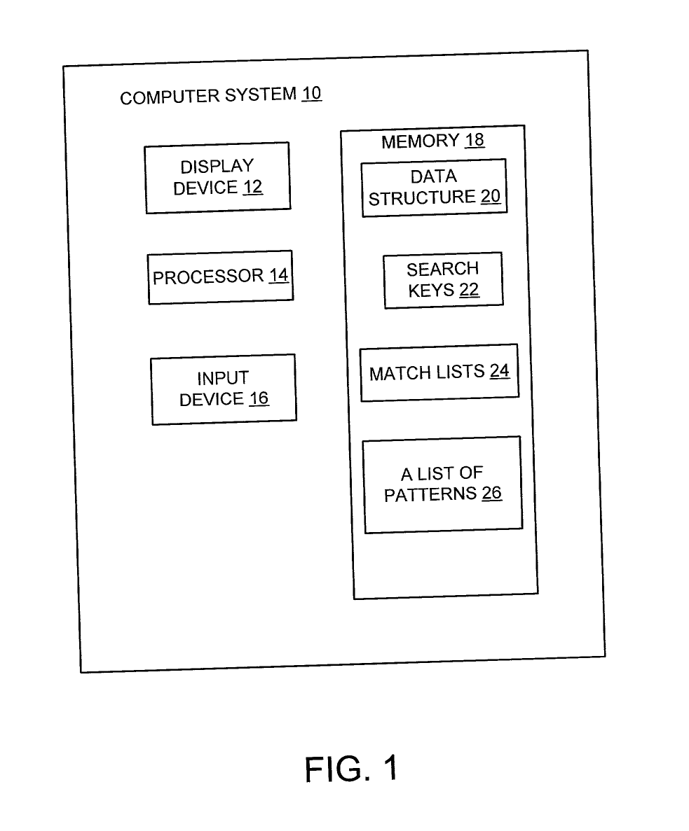

A block diagram of a computer system according to an embodiment of the present invention is shown in FIG. 1, and indicated generally at 10. As with most typical computer systems, there is a display device 12 for displaying data to users, a processor 14 for processing data, an input device 16 for users to input data, and memory 18 for storing the data. The processor 14 accesses the memory 18, which may store, among other things, data structures 20, search expressions 22, match lists 24 and a list of patterns 26.

Data structures 20 are generated by the processor 14 from a list of patterns 26 defined and entered by users. In one embodiment, the data structure is a radix tree, which is a special type of binary tree used to store collections of arbitrary-length bit strings. However, it should be understood that other data structures, such as a database, can also be implemented with the present invention. As a result, these various implementations are within the scope of the present invention. After a data structure 20 has been generated (e.g., a radix tree), a search expression 22, preferably defined by the user, is used for searching against a specified data structure, which is processed by the processor 14. A match list 24 is thus generated by the search process, and stored to memory 18. The result of the analysis may then be displayed on the display device 12 to the users.

As a result of the many possible implementations for the present invention, an explanation of the current embodiment of the computer system is given as an example. However, it should be understood that the present invention can be implemented in various computer codes, such as machine codes, and firmware. In addition, the present invention can be implemented with different types of data structures, such as database and dictionary. As a result, it should be understood that others skilled in the art can appreciate the implementations of the various systems and configurations, and these implementations are within the scope of the present invention. However, a radix tree is used as the data structure according to one embodiment, and the present invention will be explained and described with a radix tree implementation as the data structure.

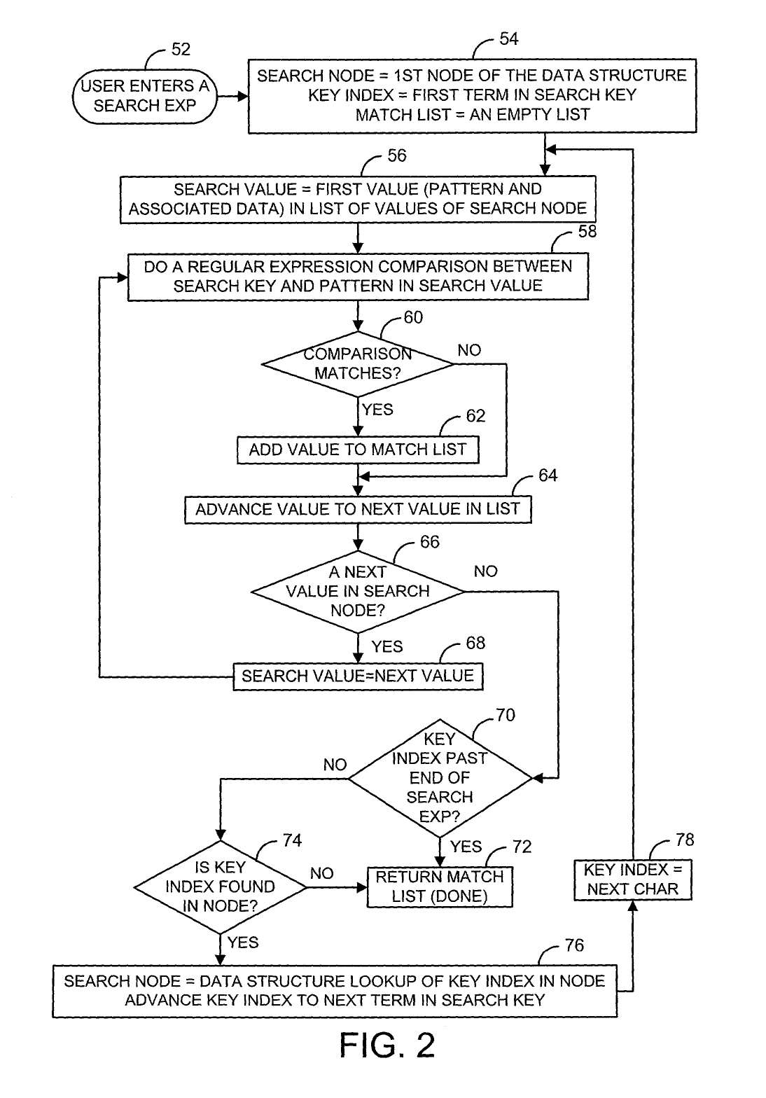

One embodiment of a method for searching a search expression 22 through a data structure 20 in accordance with the invention is shown in FIG. 2. The method is initiated by a user, through the input device 16, by calling a command to start the method. However, automatic initiation by a computer program is also contemplated, depending on the design and needs of the implementation. A user enters a search expression for searching against one or more data structures (block 52). If there are multiple search expressions or/and data structures, the present invention can be automatically set up to reiterate the method for the multiple search expressions and/or data structures.

Upon the start of the method (block 52), the method first performs some initialization commands including, for example, setting variables needed in the method (block 54). In this embodiment, a search node is set to a first node of the data structure, a key index is set to a first term in the search expression entered by the user, and a match list is set to an empty list (block 54). It should be noted that the first term in the search expression can be set in a number of ways, even though, in this embodiment, the search logic starts from the beginning and search one single character at a time. For example, the first term can be a prefix defined by one or more characters or part of a single character located at the start of the search expression, or it can also be a suffix defined by one or more characters or part of a single character located at the search expression. Thus, these various implementations are contemplated, and they are within the scope of the present invention. However, for clarification, a character refers to a single character in the search expression, and a term refers to one or more characters or part of a single character in the search expression specified by the engineer of the method search where the search should start in the search expression. In addition, the names of these variables and the order in which each variable is set are not important. Moreover, requirements for initialization are implementation specific. Nevertheless, any variables needed for the process are defined at the start of the method in this embodiment.

Once the search node has been set as the first node of the data structure (block 54), a next variable, the search value, is set as a first value of a list of values of the search node (block 56). Regardless of the type of data structure used, the data structure should have a set of ordered nodes, which are generally used for referring to a point or vertex in a graph. In turn, each node will contain keys, and some keys are associated with values containing patterns and data associated with the patterns (“associated data”). Since the search start at the beginning of the data structure, the search node is defined as the first node (i.e., point) in the data structure. Similarly, with the first node of the data structure, the first value of the first node is also used as the first search value in this embodiment. By setting the search node and the search value, the method can start from the beginning and recurse back until each value of the node and each node of the data structure have been processed.

Taking the first value of the search node as the current search value (block 56), the next step is to perform a regular expression comparison between the search expression and the pattern in the search value (block 58). In practice, since a regular expression defines multiple nonregular expressions, all the possible nonregular expressions (e.g., patterns) are compiled into a finite state machine. From the finite state machine, it is then determined whether there is a match for the search expression. A regular expression comparison is well known in the art, and various implementations to perform such a comparison are known to artisans.

After the comparison has been completed (block 58), it is next determined whether there are any matches for the search expression (block 60). If so, the value currently defined as the search value is added to the match list 24 (block 62). If either the comparison did not find a match (block 60) or the matched value has been added (block 62), the method continues and advances the search value to the next value in the list associated with the search node (block 64). It is next determined whether there is such a next value in the list of values associated with the search node (block 66). Since the first value is used, there may be a next value in the currently defined search node (block 66). In this case, this next value is set as the search value (block 68), and the method reloops to perform a regular expression comparison for the newly defined search value (block 58).

As shown, the method will keep relooping until all the values of the search node are processed. However, once it has been determined that there is not another next value associated with the search node (block 66), the method next determines whether the key index is past the end of the search expression (block 70). In other words, it is determined whether the term in the search key defined as the key index is past the end of the search expression. If so, it indicates that each term in the search expression has been processed. The match list is returned to the user (block 72) and the process ends at this point. However, if the key index is not past the end of the search expression (block 70), it is then determined whether the key index, which was the first term in the search expression (block 54), is defined as a node in the data structure (block 74). If there is a node in the data structure that is the same as the key index (block 74), the search node is reset for the node found in the data structure that matched the key index (block 76). In addition, the method will advance the key index to the next term in the search expression (block 76), and the key index will also be reset to the next term (block 78). From this point, the method reloops to the step of setting the first value of the newly defined search node as the search value (block 56). However, if there is not a node in the data structure defined as the key index (block 74), the match list is returned to the user (block 72) and the process ends.

Because of the configuration of the search method, only parts of the data structure are searched against the search expression. In contrast to the previous methods, the present invention does not waste time searching every value in the data structure. Instead, it runs through only the points (e.g., keys in a node) in the data structure that would most likely match the search expression. The length of the search depends upon the length of the search expression, rather than the length of the data structure.

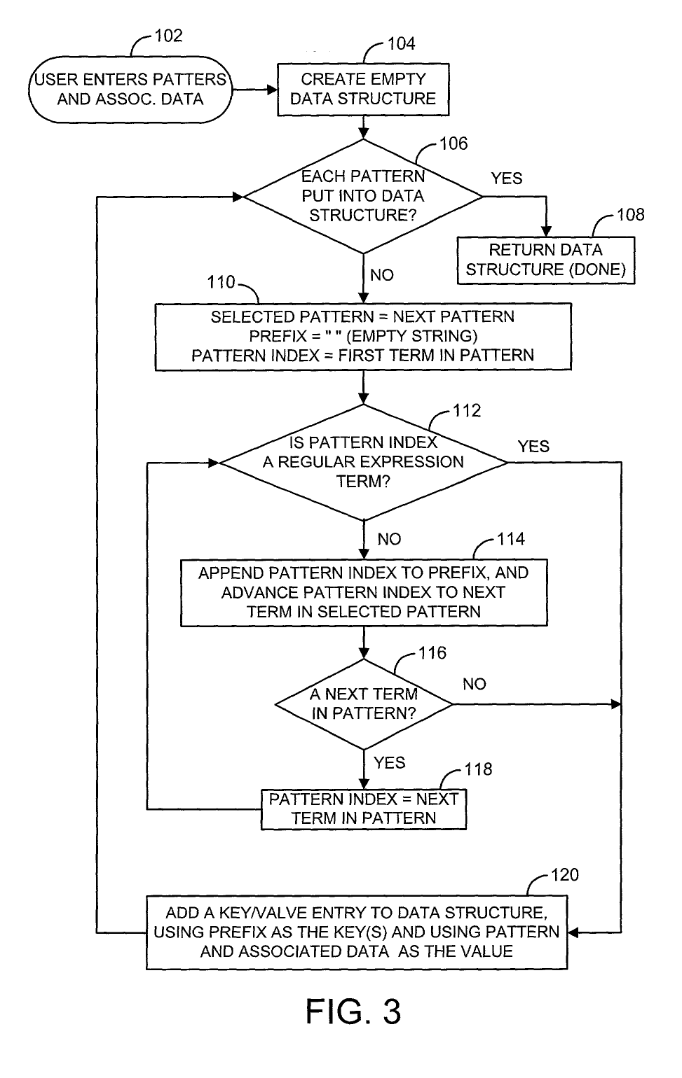

The present invention also provides a method for building a data structure designed to be used with the searching method shown in FIG. 2. An embodiment of a functionality of the method for building a data structure is shown in FIG. 3. In this embodiment, the building method is again initiated by a user, through the input device 16, calling a command to start the method. However, automatic initiation by a computer program is also contemplated, depending on the design and needs of the implementation. A user, in this embodiment, enters a list of patterns and associated data (block 102). After the user has generated a list of patterns and associated data for building the data structure (block 102), the building method first initializes by creating an empty data structure (block 104).

The next step is to determine whether each pattern entered by the user has been put into the data structure (block 106). If so, it means that all the user entered patterns have been processed and the method will return the data structure to the user (block 108). However, since an empty data structure has been created and no pattern has been processed, it will be determined that not every pattern has been entered into the data structure (block 106). In this case, the variables that are needed for the method will be set. More specifically, a next pattern, which is the first pattern entered by the user, will be set as a selected pattern, and an empty string (i.e., “ ”) is set as a prefix for the selected pattern (block 110). Finally, a pattern index is also set as the first term in the selected pattern (block 110).

After the variables have been set (block 110), it is next determined whether the pattern index is a regular expression term (block 112). If the pattern index is not a regular expression term (block 112), the pattern index is appended to the prefix and advanced to a next term in the selected pattern (block 114). It is next determined whether such a next term, in fact, exists in the selected pattern (block 116). If so, the pattern index will then be reset as the next term (block 118), and relooped to the step of determining whether the newly defined pattern index is a regular expression term (block 112). The subroutine will run until either all the terms in the selected pattern have been processed or a term in the selected pattern is found to be a regular expression.

If, on the other hand, either the pattern index is a regular expression term (block 112) or all the terms in the selected pattern have been processed (block 116), a key and a value entry are added to the data structure (block 120). In particular, the prefix is defined as key(s) for the node(s) and the pattern with its associated data as the value in the data structure (block 120). The method is then relooped back to the step of determining whether each pattern has been put in the data structure (block 106), and it will keep recursing until all the patterns have been processed and a data structure is returned (block 108). As shown, the data structure is configured such that the values with a regular expression term at the beginning of the pattern will be search by the search method, and the search is also narrowed to only parts of the data structure that matches the nonregular terms located at the start or the end of the search expression is searched.

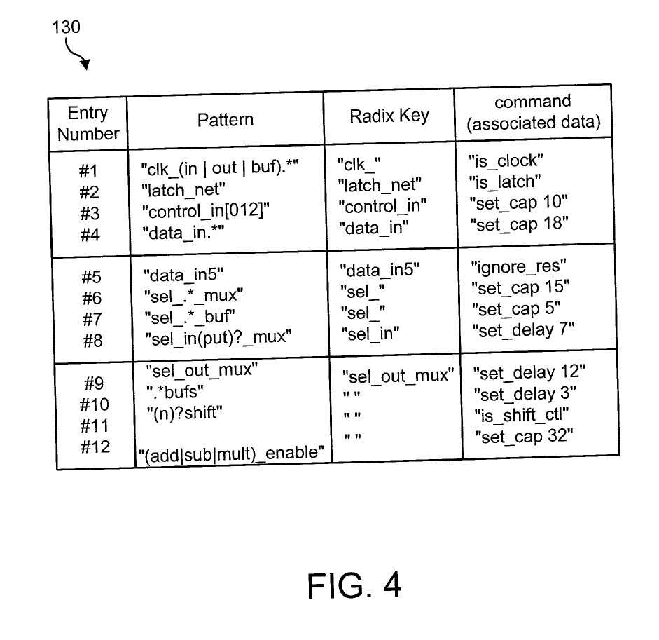

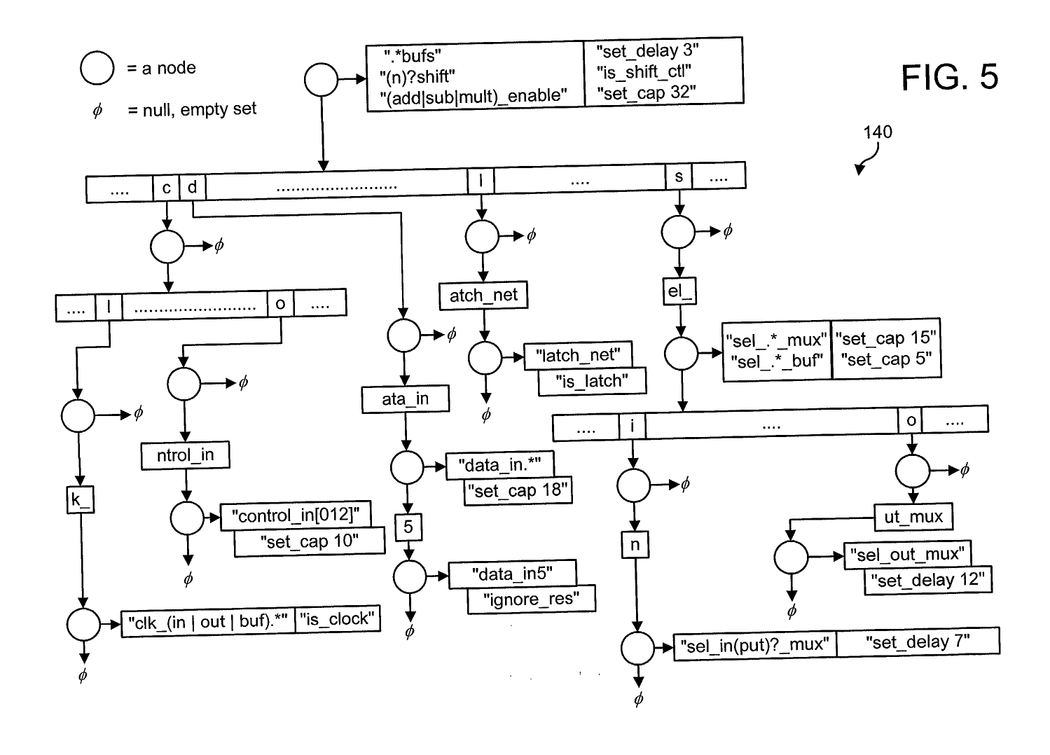

Exemplary radix keys generated using user defined entries of pattern and associated data and the resultant radix tree data structure generated are respectively shown in FIGS. 4 and 5 and indicated generally at 130, 140, which will be used as an example for processing through the methods shown in FIGS. 2 and 3. Turning to the first user entry (i.e., entry #1) in FIG. 4 and relating to the method shown in FIG. 3, let the user entered pattern “clk_(in|out|buf).*” be defined as the selected pattern (i.e., selected pattern=“clk_(in|out|buf).*”), and note that the associated data for this entry is “is_clock”. The prefix is set as an empty string (i.e., prefix=“ ”), and the pattern index will be set as “c” (i.e., pattern index=“c”). Note that in this example, the first term is configured as a single character at the beginning of the pattern. However, once again, it should be understood that multiple characters at various locations are contemplated, and are within the scope of the present invention. As shown, since “c” is not a regular expression, the pattern index will be appended to the prefix. In other words, the prefix will be appended with the pattern index (i.e., prefix=“; c”).

Turning to the next term in the pattern “1”, the pattern index is then set to “1” (i.e., pattern index “1”). This is again not a regular expression, so the “1” is appended to the prefix (i.e., prefix=“; c; 1), and the same thing is true for “k_” (i.e., prefix=“; c; 1; k_). However, when we get to the “(” in the selected pattern, which is a regular expression, a key for the prefix and a value for the pattern and associated data are added to the data structure. In this example, we will have a key “ ” (empty string), followed by a “c”, “1” and “k”, which is where the value would be found.

Turning now to FIG. 5, we see a “ ” (empty string) as the top node, which branches off to a node with “c” and followed by another node with key “1” and key “k” with the pattern and associated data. If all the entries from FIG. 4 have been processed, a data structure, which is a radix tree in one embodiment shown in FIG. 5, will be generated. More specifically, the type of radix tree shown in FIG. 5 is a Trie. However, it should be understood that the present invention also contemplates the use of different types of radix trees, and other various implementations are within the scope of the present invention. This example shows how the building method shown in FIG. 3 works with an example.

Using the data structure shown in FIG. 5, a search expression, for example “clk_bufs”, can be easily searched against the data structure using the search method shown in FIG. 2. First, the top node (e.g., the first node) of the data structure is set as the search node (i.e., search node=“ ”), and the first term of the search expression is set as the key index (i.e., key index=“c”). From the search node, the first value is set as the search value (i.e., search value=“.*bufs” and “set_delay 3”). After performing a regular expression comparison between the search expression (i.e., “clk_bufs”) and the pattern in the search value (i.e., “.*bufs”), and a match is found, the value will be added to the match list. The subroutine will keep relooping for the remaining values of “(n)?shift”/“is_shift_ctl” and “(add|sub|mult)_enable”/“set_cap 32”. However, as shown, the patterns of these other values do not match the search expression.

After completing the search for the search node of an empty string (i.e., “ ”), it is next determined whether the key index is past the end of the search key. Since the key index (e.g., “c”) is the first term in the search expression and the length of the search expression (e.g., clk_bufs) has 8 characters, the key index, in this loop, is not past the end of the search key. As a result, it is next determined whether the key index of “c”, which was defined in an earlier step, can be found in the node. Referring to FIG. 5, a key “c” in the node is found, and the search node will be reset as the “c” key index in the node. The key index is also advanced to the next term in the search by setting it as a newly defined key index. The method reloops to the step of resetting the search value for the newly defined search node. The method again keeps recursing, and eventually, it will find the value “clk_(in|out|buf).*”/“is_clock” in FIG. 5.

From the foregoing description, it should be understood that an improved system and method for searching for a list of values matching a user defined search expression and building a data structure with a list of values for the searching have been shown and described, which have many desirable attributes and advantages. The system and method provide a faster way for searching through a data structure using a specified search expression.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method for searching for a list of values defined by patterns and associated data matching a user defined search expression, wherein a data structure is used to store a plurality of values linked by keys associated with a collection of ordered nodes, said method comprising the steps of:
setting a key index as a first term in the search expression;
setting a search node as a first node in the data structure;
setting a search value as a first value having a pattern and associated data in the search node;
performing a regular expression comparison between the search expression and the pattern of the search value;
determining whether a match is found from the regular expression comparison; and,
if a match is found, adding the search value to a match list.

2. The method according to claim 1 wherein a first term in the search expression refers to a prefix defined by at least one character or part of a character located at the start of the search expression or a suffix defined by at least one character or part of a character located at the end of the search expression.

3. The method according to claim 1 wherein prior to said step of setting a search node as a first node in the data structure further comprises a step of resetting the match list to an empty list.

4. The method according to claim 1 wherein said step of determining whether a match is found from the regular expression comparison further comprises the steps of:
if a match is not found, advancing value to a next value in the search node;
determining whether there is a next value in the search node;
if there is a next value in the search node, setting the search value as the next value and repeating from the step of performing a regular expression comparison between the search expression and the pattern of the search value; and,
if there is not a next value in search node, determining whether the key index is past an end of the search expression.

5. The method according to claim 4 wherein said step of determining whether in the key index is past an end of the search expression further comprises the steps of:
if the key index is not past the end of the search expression, determining whether the key index is found as a key in the data structure; and,
if in the key index is past the end of the search expression, return the match list.

6. The method according to claim 5 wherein said step of determining whether the key index is found as a key in the data structure further comprises the steps of:
if the key index is not found in the data structure, returning the match list; and,
if the key index is found in the data structure, setting the search node as the node with the key index.

7. The method according to claim 6 wherein said step of setting the search node as the node with the key index further comprises the step of:
advancing to a next term in the search expression;
setting the key index as the next term in the search expression; and,
repeating from said step of setting a first value in the search node.

8. A method for searching for a list of values defined by patterns and associated data matching a user defined search expression, wherein a data structure is used to store a plurality of values linked by keys associated with a collection of ordered nodes such that at least one node for storing values with a first term being a regular expression term and at least one node for storing values with a first term not being a regular expression, said method comprising the steps of:
performing a regular expression comparison between the search expression and the pattern of each value in at least one node storing values with a first term being a regular expression term;
performing a regular expression comparison between the search expression and the pattern of each value in a node storing values with a first term matching a first term in the search expression; and,
if a match is found, adding the value to a match list.

9. A method for building a data structure with a list of user defined values, wherein each value is defined by a pattern and associated data, said method comprising the steps of:
selecting a user defined value having a pattern and associated data from the list;
setting a selected pattern as the pattern of the selected value;
setting a prefix as an empty string for the selected pattern;
setting a pattern index as a first term in the selected pattern;
determining whether the pattern index is a regular expression term;
if the pattern index is a regular expression term, adding the prefix as a key and adding the selected pattern with its associated data as a value to the data structure; and,
if the pattern index is not a regular expression term, appending the current pattern index to the prefix and advancing to a next term in the selected pattern.

10. The method according to claim 9 prior to said step of adding the prefix as a key and adding the selected pattern with its associated data as a value to the data structure further comprises the step of creating an empty data structure.

11. The method according to claim 9 wherein said step of advancing to a next term in the selected pattern further comprises the steps of:
determining whether there is a next term in the selected pattern;
if there is a next term in the selected pattern, setting the pattern index as the next term, and repeating from said step of determining whether the pattern index is a regular expression term;
if there is not a next term in the selected pattern, repeating from said step of adding the prefix as a key and adding the selected pattern with its associated data as a value to the data structure.

12. The method according to claim 9 wherein said step of adding the prefix as a key and adding the selected pattern with its associated data as a value to the data structure further comprises the steps of:
determining whether each pattern of the user defined values is added to the data structure;
if each pattern has not been added to the data structure, repeating from said step of selecting a user defined value having a pattern and associated data from the list; and,
if each pattern has been added to the data structure, returning the data structure.

13. A system for searching for a list of values defined by patterns and associated data matching a user defined search expression, said system comprising:
means for performing a regular expression comparison between the search expression and a list of values having a first term as a regular expression term; and,
means for performing a regular comparison between the search expression and a list of values having a first term as a nonregular expression term.

14. A system for building a data structure with a list of user defined values, wherein each value is defined by a pattern and associated data, said system comprising:
means for generating a list of values having a first term as a regular expression term; and,
means for generating a list of values having a first term as a nonregular expression term.

15. A computer program product comprising a computer usable medium having computer readable program codes embodied in the medium that when executed causes a computer to:
set a key index as a first term in the search expression;
set a search node as a first node in the data structure;
set a search value as a first value having a pattern and associated data in the search node;
perform a regular expression comparison between the search expression and the pattern of the search value;
determine whether a match is found from the regular expression comparison; and,
add the search value to a match list if a match is found.

16. A computer program product comprising a computer usable medium having computer readable program codes embodied in the medium that when executed causes a computer to:
select a user defined value having a pattern and associated data from the list;
set a selected pattern as the pattern of the selected value;
set a prefix as an empty string for the selected pattern;
set a pattern index as a first term in the selected pattern;
determine whether the pattern index is a regular expression term;
add the prefix as a key and adding the selected pattern with its associated data as a value to the data structure if the pattern index is a regular expression term; and,
append the current pattern index to the prefix and advancing to a next term in the selected pattern if the pattern index is not a regular expression term.
